(19) United States
(12) Patent Application Publication
(10) Pub. No.: US 2003/0147359 A1
(43) Pub. Date: Aug. 7, 2003

(54) Long-distance network transmission structure and associated device

(75) Inventor: Murphy Chen, Taipei (TW)

Correspondence Address: ARENT FOX KINTNER PLOTKIN & KAHN, PLLC, 1050 Connecticut Avenue, N.W., Suite 400, Washington, DC, 20036-5339, US

(73) Assignee: VIA TECHNOLOGIES, INC.

(21) Appl. No.: 10/338,733

(22) Filed: Jan. 9, 2003

(30) Foreign Application Priority Data
Feb. 7, 2002 (TW) 91102224

(51) Int. Cl. H04B 3/36

(52) U.S. Cl. 370/293

(57) ABSTRACT

This invention discloses a long-distance network transmission structure and associated device thereof. The invention utilizes the CAT-5 transmission line network to achieve a high-speed long-distance network tranceiving. A DSP PHY (Digital Signal Processing Physical) is employed in the long-distance network transmission structure to receive a data signal from the transmission line. The signal is then driven to clients with a common PHY without DSP capability or a DSP PHY. Through such a DSP PHY, the signal can be transmitted over 3000 ft and the transmission rate can reach duplex 100 Mbps. Two pairs of cords inside the CAT-5 network transmission line are used to provide the full duplex data tranceiving and the other two spare cords provide electrical power for a repeater. Therefore, the long-distance transmission structure and associated device thereof can effectively reduce the cost for both network service providers and clients and facilitate the installation.

### BACKGROUND OF THE INVENTION

1. Field of the Invention

The invention relates to a network transmission structure and associated device thereof. More particularly, the invention applies a digital signal processing physical (hereinafter as DSP PHY) to implement long-distance network transmissions.

2. Description of the Related Art

Due to tremendous progress in the information technology, conventional information applications have been evolved from simple operations, word processing and local area network (LAN) applications into network information transmissions over wide area networks (WAN). Moreover, with the improvements of personal computers (PCs) and even lower prices, data processing systems have become very popular. After the Internet applications prevail from original academic research to commerce, more people can enjoy new technologies, cheaper fee, and abundant resource. Besides, multimedia technologies such as hypertext and web technology result in rapid growth in Internet. As the multimedia data contents become more various, data transmission flow also increases. Real-time applications as network telephones, video conference, and video on demand become more popular. Therefore, broadband multimedia network that can transmit a huge amount of data in real time. Consequently, increasing the network transmission speed already becomes an important issue in Internet.

There are three ways for increasing the network speed. (1) Use existing network systems already installed and improve the technology so as to provide high-speed transmission. Taking the xDSL system as an example, conventional telephone network is utilized to provide higher transmission bandwidth. (2) Use non-computer network and develop new technologies and equipment. The development in the cable modem and hybrid fiber coaxial (HFC) network is a good example. It uses existing cable TV networks for high-speed data transmission. (3) Develop a new technology to build a high-speed information network system. Such examples are the asynchronous transfer mode (ATM), fast Ethernet, and Giga switch.

In regard to the xDSL, telephone companies experience increasing demands for broad bandwidth from their clients and the competition from cable TV companies that actively improve their network structures and provide integrated network services. In the early 1990s, American telephone companies put their emphases on acquiring cable TV companies or even run cable TV business worldwide because of the high popularity and the broadbands service of the cable TV. However, they forgot the advantages of their own networks. For these telephone companies, using the xDSL technology on the existing telephone networks to provide high-speed network services is the more practical strategy that should be taken. xDSL is the term for a technology that was developed by Bellcore and AT&T in late 1980s. It mainly uses a new-generation modulation technology with different digital levels to provide high-speed digital transmission services over conventional telephone lines.

DSL is abbreviated from digital subscriber line. Persons skilled in the art note that the network signal is digitized for transmission. However, the telephone lines conventionally deliver analog signals such as voices. In order to connect to the network using a telephone line, one may adopt modems (Modulator-Demodulator), for converting digital signals into analog signals transferred over the telephone line. DSL modulates digital signals on the telephone line. Therefore, it provides larger bandwidth and higher speed than conventional modems. Currently, 56 Kbps is the upper limit of the transmission rate on a normal telephone line for a modem. The DSL technology is an advanced modulation technology, which has DSL modems connected on both sides of a normal telephone line, utilizing the high bandwidth property of digital signals to perform high-speed data transmissions. If a separator that separates the voice-frequency bandwidth and the high bandwidth is incorporated, it can simultaneously provide telephone and high-speed digital data transmission service.

Members in the xDSL family include high bit rate DSL (HDSL), asymmetric DSL (ADSL), symmetric DSL (SDSL), ISDN DSL (IDSL), and very high bit rate DSL (VDSL). These technologies differ in signal modulation techniques, transmission speeds and distances, and other factors resulted from network terminal locations and installation cost.

VDSL has the fastest transmission rate in the xDSL family. The downloading speed is 13 to 55 Mbps, while the uploading speed is 1.5 to 2.3 Mbps. Due to its high bit rate, it is considered as a low-cost replacement of fiber to the home (FTTH) or fiber to the curb (FTTC). This type of asymmetric transmission method has a transmission distance of about 300 m from the server to the client. If one wants to elongate the transmission distance, the optical network switch unit (ONU) can be employed to achieve this objective. In this case, the fiber is used between the host to an ONU and the ordinary telephone line is used between the ONU and the client. This method can extend the transmission distance to 14km. However, there is no standard platform for the regulations of the VDSL.

With reference to FIG. 1, the VDSL network includes the central office (CO) 11, the ONU 12, the customer premises equipment (CPE). The CO 11 mainly connects to the Internet and can be viewed as a terminal of the VDSL. The CO 11 connects to the ONU 12 through an optical fiber network 111. The ONU 12 includes a switch 121 and a VDSL modem 13. Through this device, network information is provided by various network services through network. After the signal modulation by the VDSL modem 13, the data are transmitted through ordinary telephone lines 112 to another VDSL modem 13 for demodulation. The demodulated data are then provided to the client. The client equipment includes a VDSL modem 13, a network interface card (NIC) 14, and a PC 15. After the modulated data signals are transmitted to the client equipment, the VDSL modem 13 demodulates the signals to be received by the PC 15. Through the signal conversion (analog/digital conversion) by the NIC 14 and the network transmission line 113, the converted signals are transferred to the PC 15, and vice versa.

### SUMMARY OF THE INVENTION

As described above, the VDSL can use existing telephone lines to transfer data signals, be easily wired in the network, achieve a transmission distance of 3000 ft˜4000 ft, and have a transmission rate of 26 Mbps, but the cost of the VDSL modem is so high that is cannot be popularized. Furthermore, old telephone lines may significantly lower the transmission rate. Therefore, the invention provides a long-distance network transmission structure and its relevant devices to increase the transmission distance and rate of the data signals over the network. It can at the same time reduce the cost for setting up the network structure and make the installation easier. The invention can help increase the popularity and uses of such systems by the public.

A primary object of the invention is to provide a long-distance network transmission structure and relevant devices thereof. It uses repeaters with DSP PHY and CAT-5 network transmission lines to increase the transmission distance of network data. The invention can achieve a transmission distance of 400m without being limited by the grade of the client's equipment.

Another object of the invention is to increase the transmission speed of the long-distance network transmission structure. Using the invention can achieve a transmissions speed of 100 Mbps, which is of great benefit for future broadband market.

A yet another objective of the invention is to reduce the cost for installing the system by removing the VDSL modem in the prior art from equipment required by the disclosed architecture.

In view of facts that the VDSL network structure in the prior art has to use VDSL modems to modulate data signals before they can be transmitted over telephone lines at high speeds, however, the VDSL modem has such a high cost if system cannot be widely utilized, the invention provide a long-distance network transmission structure and relevant devices thereof. It utilizes a repeater with a DSP PHY chip and CAT-5 network transmission lines to enhance the long-distance network transmission ability. The disclosed structure replace a VDSL modem and does not need to change the client's devices and network wiring. However, it achieves a longer transmission distance and a higher transmission rate. The invention can reduce the cost for installing such a long-distance network transmission system as well.

### BRIEF DESCRIPTION OF THE DRAWINGS

The present invention will become more fully understood from the detailed description given herein below illustration only, and thus are not limitative of the present invention, and wherein:

FIG. 1 is a schematic view of the VDSL network transmission structure according to the prior art;

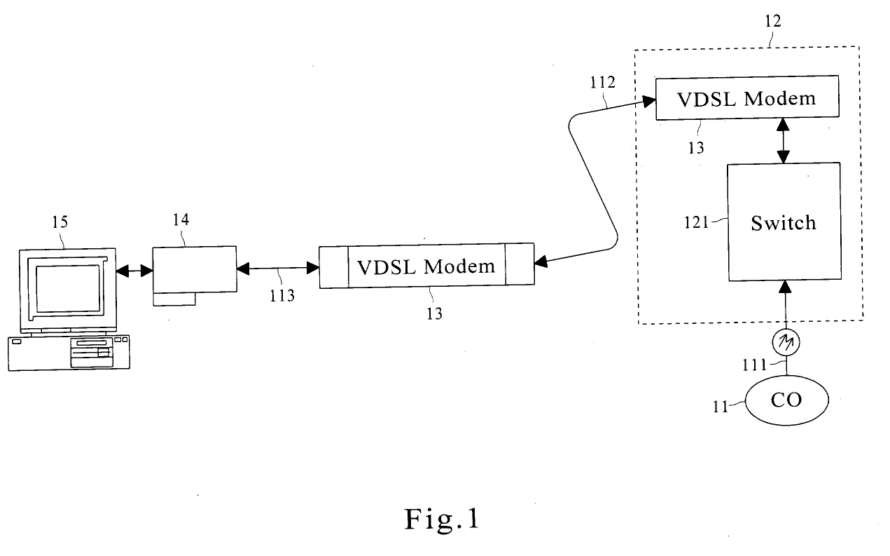

FIG. 2 is a schematic view of the long distance network transmission structure according to the present invention; and

FIG. 3 shows a block diagram for the repeater of long distance network transmission structure according to the invention.

### DETAILED DESCRIPTION OF THE INVENTION

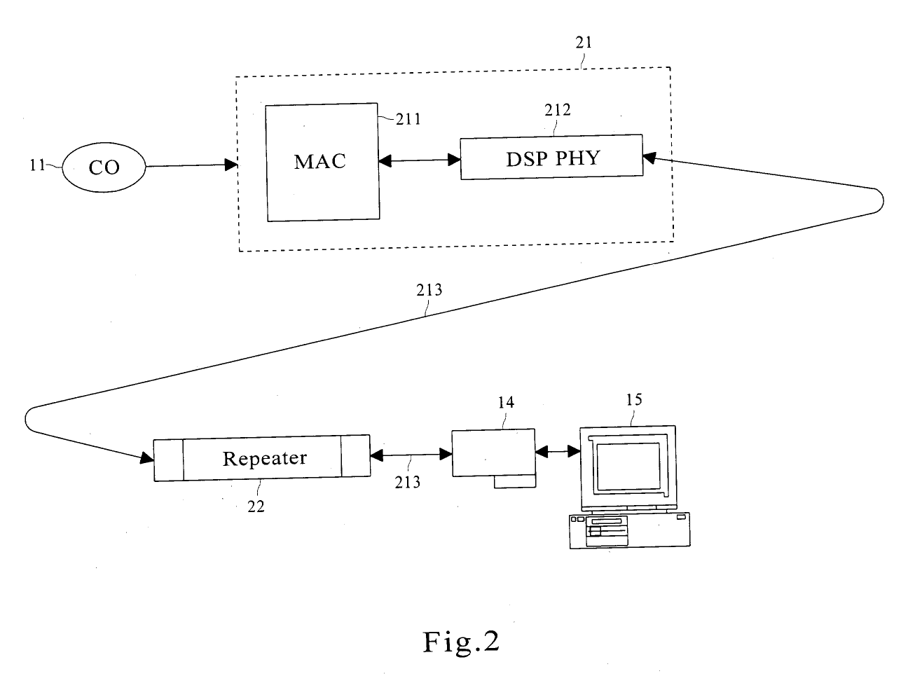

Please refer to FIG. 2 showing an embodiment of the transmission from a CO 11 to a client according to the present invention. The structure comprises: a CO 11, a network switch unit 21, a CAT-5 network transmission line 213, and a repeater 22. The CO 11 is connected to the network switch unit 21 through a network transmission line 213. The network switch unit 21 comprises a medium access unit (MAC) 211 and a DSP PHY 212, through which data signals on the network are driven to the CAT-5 network line 213. The CAT-5 (Category 5) network transmission line 213 is connected between the network switch unit 21 and the repeater 22 and between the repeater 22 and the client, wherein the transmission line 213 between the network switch unit 21 and the repeater 22 is capable of delivering power and the data signals are transferred to the repeater 22 through the network transmission line 213. The repeater 22 acquires power through the CAT-5 network transmission line connected to the network switch unit 21. Through the digitally processing and retrieving the data signals by a DSP PHY of the repeater 22, another CAT-5 network transmission line 213 transfers the signals to the client. The client includes an NIC 14 and a PC 15. The NIC 14 is used to receive data signals from the network.

Furthermore, in a network switch unit 21, DSP PHY 212 is integrated to replace the VDSL modem 13. A repeater 22 is provided between the network switch unit 21 and the client's equipment. The DSP PHY 212 of network switch unit 21 coupled to the repeater 22 utilizes special modulation and DSP techniques for long-distance network signal transmission. Power is supplied and duplex data transmission is performed on the transmission line connecting the repeater 22 and the network switch unit 21. This can be achieved using a CAT-5 network transmission line 213 because currently the CAT-5 network transmission line 213 provides four pairs of transmission lines; two of them are used to support duplex data transmission, and the other two are spare and can be used to supply electrical power.

With reference to FIG. 2, the network switch unit 21 comprises an MAC 211 and a DSP PHY 212. The network switch unit 21 exchanges information for clients in a community. In this embodiment, in order for the CO 11 to send signals to a remote client, a special modulation technique is invoked to achieve long-distance transmission. Such modulation techniques, e.g., the Gigabit modulation technique, may vary for different manufacturers, which can be understood by persons skilled in the art without further discussion herein. The signals after long-distance transmissions will experience serious interference and attenuation, the receiving party can retrieve the same using DSP.

In general, the modulated signal by a VDSL modem has a speed up to 26 Mbps and a transmission distance of 3000 ft to 4000 ft. After 300 m of long distance transmission, the signal suffers serious attenuation and is hard to be retrieved. The invention employs a DSP PHY 212 with DSP capability to perform signal modulation before sending the same to the network transmission line. The attenuated signal is processed by digital signal processing at receive end. In this case, the transmission speed can be duplex 100 Mbps and the transmission distance can be as long as 300 m to 400 m. Therefore, the long-distance transmission according to the invention provides a higher bandwidth than the VDSL. The old telephone line cannot realize data transmission with such a high speed. The invention utilizes CAT-5 network transmission lines 213 existing in most new communities as the medium to couple the network switch unit 21 to the repeater 22 and to couple the repeater 22 to the client. It is preferred that the power of the repeater 22 is acquired from the network switch unit 21 through the CAT-5 network transmission line 213.

The CAT-5 network transmission line 213 is a common transmission line. It is cheap, but has a transmission speed larger than 100 Mbps. For the current situation, most newly built communities or buildings are provided with the CAT-5 network transmission lines 213 at low cost. As they have a broader transmission bandwidth and a larger transmission speed, it is very suitable to apply them in the duplex transmission lines for the long-distance network transmission structure according to the present invention. Another advantage of the CAT-5 network transmission lines 213 is that they contain four pairs of transmission cords. Currently, only two of them are used as described above for the duplex data signal transmissions, while the other two are spare ones. The invention, nevertheless, utilizes them to carry power, supplying electrical power for the repeater 22. Thus, the volume of the repeater 22 is reduced and no extra power supply is required so that the installation becomes much simplified.

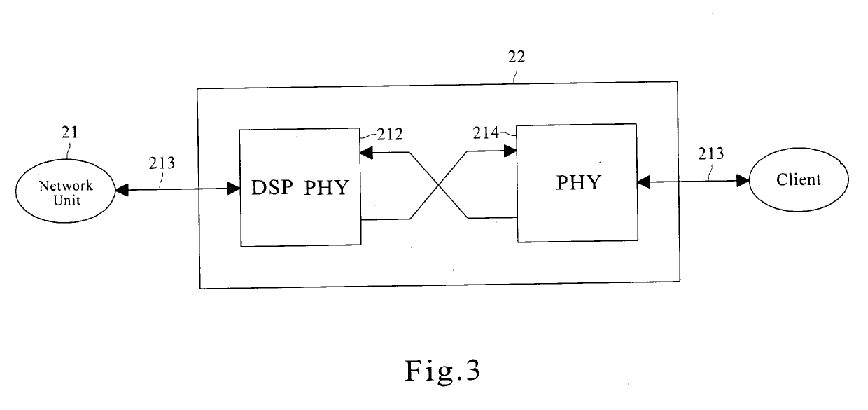

As mentioned before, the data signal sent out from the network switch unit 21 reaches the repeater 22 through the CAT-5 network transmission line 213. Since the data signals after 300 m of transmission will attenuate and experience significant drift and deformation, the client may not be able to identify and retrieve such signals. Thus, the repeater 22 is provided here to perform DSP demodulation and remodulate the same, so as to send the signal to the client. As shown in FIG. 3, the repeater 22 includes a first terminal interface and a second terminal interface according to the present invention. The first terminal interface is connected to a network switch unit 12 through a long (300 m to 400 m) CAT-5 network transmission line 213, which simultaneously provides electrical power and duplex data transmission capability. The first terminal interface is a DSP PHY 212. The second terminal interface is connected to the client through another transmission line. It can be a common PHY 214 without DSP capability or a DSP PHY. In this embodiment, the repeater 22 and the network switch unit 12 are connected through a long-distance CAT-5 network transmission line 213. Therefore, the first terminal interface uses this DSP PHY 212 retrieve the drifted and deformed data signals on the CAT-5 network transmission line 213. The first terminal interface of the repeater 22 is capable of retrieving data signals through a long-distance network transmission line. The second terminal interface does not require an expensive DSP PHY. It can be simply a common PHY without DSP capability.

With further reference to FIG. 3, the CAT-5 network transmission line 213 has two pairs of lines to provide electrical power for the repeater 22. Therefore, the first terminal interface inside the repeater 22 to connect with the network switch unit 21 has the capability to receive remote power supply. After the data signals being retrieved by the DSP PHY 212, the data signal is transmitted to the PHY 214. Since most NICs 14 on the market only has standard data transmission capability. Thus, the signal retrieved by the DSP PHY 212 is further modulated by the common Ethernet PHY 214, so as to be recognized by the PHY inside the NICs 14. Therefore, clients do not need to upgrade the conventional NICs 14 in the PCs 15, thus saving cost for clients.

Generally speaking, in order not to destroy the appearance of buildings in a community, the repeater 22 is installed in the transformer box of the building or the community. The repeater 22 requires DC power. Therefore, DC power source is conventionally obtained by converting the AC power supply to DC. Since there is very limited space within the transformer box, it is not only hard for installation but may also result in danger because components therein become too crowded and dangerous. Therefore, the invention applies CAT-5 network transmission lines 213 to carry power for the repeater 22. This can reduce the cost and volume of the repeater 22 and facilitates the installation as well.

The repeater 22 comprises a miniature circuit board having a single chip with two ports, an associated circuit, a rectifier, and two connectors. The required power is obtained remotely through the CAT-5 transmission line, connectors, and rectifier. Therefore, this circuit board can be very small so that the whole repeater 22 becomes compact to be installed at any place conveniently. Consequently, the die size of the two-port single chip according to this invention is very small and cheap.

After the modulation of the PHY 214 in the repeater 22, the signal is transmitted to the client through the CAT-5 network transmission line 213. Since now the data signals can be recognized by the NIC 14, the client conveniently prepares a CAT-5 network transmission line 213 to connecting the NIC 14 to the repeater 22. The PC 15 is then able to access a remote network terminal through the long-distance network structure according to the present invention and the NIC 14 without requiring any expensive VDSL modem. Meanwhile, the invention facilitates the installation of the associated repeater without requiring any additional power supply.

With the long-distance network transmission structure and associated devices being described, person skilled in the art will be able to clearly understand the spirits and make various equivalent modification and changes without departing from the scope of the invention.

Effects of the Invention

The long-distance network transmission structure and associated devices according to the present invention have many advantages and features. In particular, the data signal transmission rate is duplex 100 Mbps. The transmission distance can be as long as 300 m to 400 m. Moreover, the invention can save the hardware cost for both the network service providers and the clients.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A long-distance network transmission structure, comprising:
a network switch unit, which exchanges a data signal between a first network and a second network; and
a repeater, which has a first terminal interface connected to the network switch unit through a first network transmission line and a second terminal interface connected to a client terminal through a second network transmission line;
wherein the first terminal interface has a digital signal processing physical (DSP PHY) to receive said data signal from the first network transmission line through DSP so that the length of the first network transmission line is longer than that of the second network transmission line.

2. The long-distance transmission structure of claim 1, wherein said first network transmission line supplies electrical power.

3. The long-distance transmission structure of claim 1, wherein said first terminal interface supports full duplex data tranceiving.

4. The long-distance transmission structure of claim 1, wherein said first network transmission line is a CAT-5 network transmission line.

5. The long-distance transmission structure of claim 4, wherein said CAT-5 network transmission line comprises four pairs of transmission cords, two of them providing power supply and the other two supporting full duplex data tranceiving.

6. The long-distance transmission structure of claim 4, wherein said CAT-5 network transmission line has a length over 3000 ft.

7. The long-distance transmission structure of claim 1, wherein said client terminal includes a network interface connected with the second network transmission line.

8. The long-distance transmission structure of claim 1, wherein said second terminal interface includes a PHY.

9. The long-distance transmission structure of claim 1, wherein said second network transmission line is a CAT-5 network transmission line.

10. The long-distance transmission structure of claim 1, wherein said interface of the network switch unit that connects to the first network transmission line comprises a DSP PHY to receive said data signal from the first network transmission line through DSP.

11. A repeater comprising:
a first terminal interface, which has a DSP PHY connected to a network switch unit through a first network transmission line; and
a second terminal interface, which has a PHY connected to a client terminal through a second network transmission line;
wherein the DSP PHY on the first terminal interface tranceives a signal through the first network transmission line so that a length of the first network transmission line is longer than that of the second network transmission line.

12. The repeater of claim 11, wherein said first network transmission line and said second network transmission line are CAT-5 network transmission lines.

13. The repeater of claim 11, wherein said first network transmission line delivers electrical power.

14. The repeater of claim 11, wherein said first network transmission line has four pairs of transmission cords with two of them supplying electrical power and the other two performing full duplex data tranceiving.

15. The repeater of claim 11, wherein said first terminal interface and said second terminal interface support full duplex tranceiving.

16. The repeater of claim 11, wherein the length of said first network transmission line exceeds 3000 ft.

17. The repeater of claim 11, wherein the interface of said network switch unit that connects to the first network transmission line comprises a DSP PHY for tranceiving said signal from the first network transmission line using DSP.
